(19) United States
(12) Patent Application Publication
(10) Pub. No.: US 2006/0255779 A1
(43) Pub. Date: Nov. 16, 2006

(54) LINEAR VOLTAGE REGULATOR

(76) Inventors: Yong-Zhao Huang, Shenzhen (CN); Wu Jiang, Shenzhen (CN); Yong-Xing You, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,624

(22) Filed: Jan. 4, 2006

(30) Foreign Application Priority Data
May 14, 2005 (CN) 200510034681.4

(51) Int. Cl. G05F 1/00

(52) U.S. Cl. 323/273

(57) ABSTRACT

A linear voltage regulator includes an error amplifier receiving an operational voltage and provided a control signal, a pass device controlled by the control signal and providing a load voltage from a power supply, and a leakage circuit controlled by the control signal and consuming a drive-back current. Since the linear voltage regulator includes the leakage circuit, a drive-back current created can be grounded via the switch transistor of the leakage circuit. Thereby an impedance calibration of termination transistors will be normal, and a life span of electronic components will be protected.

### FIELD OF THE INVENTION

The present invention relates to the field of power supplies, and particularly to a linear voltage regulator for providing a regulated voltage to electronic devices.

### DESCRIPTION OF RELATED ART

DC-to-DC power converters are widely used to supply power to electronic devices, such as computers, printers, etc. Such linear voltage regulators are available in a wide variety of configurations for many different applications.

Referring to FIG. 1 a typical linear voltage regulator includes an error amplifier 1, and a pass device 2. A MOSFET transistor is used as the pass device 2. An inverting input of the error amplifier 1 is connected to a source of the pass device 2 for sensing an output voltage. A voltage reference Vref is fed to a non-inverting input of the error amplifier 1. A control signal from the output of the error amplifier 1 is fed to a gate of the pass device 2 to control the pass device 2. The pass device 2 provides current from a power supply Vin to a load 5 under the control of the error amplifier 1 to thereby maintain a desired output voltage despite fluctuations in the load 5.

However, the typical linear voltage regulator is without current sink capabilities. When there is a voltage delta appears, a back-drive current created by the voltage delta cannot be consumed. For example, when the typical linear voltage regulator provides voltage to a front side bus (FSB), there is possibility a voltage delta appears due to a difference in a processor and a memory controller hub (MCH). When the FSB is inactive, the voltage delta creates a condition where a higher processor voltage creates a back-drive current in the MCH termination. Since a MCH leakage current or the typical linear voltage regulator cannot consume the back-drive current, the processor voltage will increase beyond the regulation limits. As a result, an impedance calibration of the active MCH front side bus termination transistors will be impacted. And the heightened processor voltage may also reduce a life span of the MCH.

What is desired, therefore, is a linear voltage regulator which has current sink capabilities.

### SUMMARY OF INVENTION

In one preferred embodiment, a linear voltage regulator comprises an error amplifier receiving an operational voltage and provided a control signal, a pass device controlled by the control signal and providing a load voltage from a power supply, and a leakage circuit controlled by the control signal and consuming a drive-back current. Since the linear voltage regulator includes the leakage circuit, a drive-back current created can be grounded via the switch transistor of the leakage circuit. Thereby an impedance calibration of termination transistors will be normal, and a life span of electronic components will be protected.

Other advantages and novel features will become more apparent from the following detailed description of preferred embodiments when taken in conjunction with the accompanying drawings, in which:

### BRIEF DESCRIPTION OF DRAWINGS

FIG. 1 is a circuit diagram of a typical linear voltage regulator;

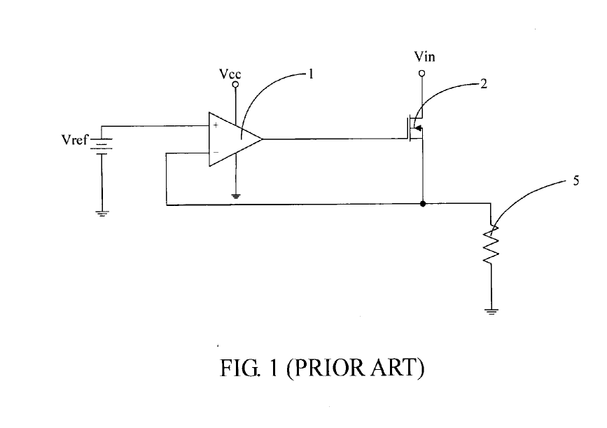

FIG. 2 is a circuit diagram of a linear voltage regulator of a first preferred embodiment of the present invention;

FIG. 3 is a circuit diagram of a linear voltage regulator of a second preferred embodiment of the present invention;

FIG. 4 is a circuit diagram of a linear voltage regulator of a third preferred embodiment of the present invention; and

FIG. 5 is a circuit diagram of a linear voltage regulator of a forth preferred embodiment of the present invention.

### DETAILED DESCRIPTION

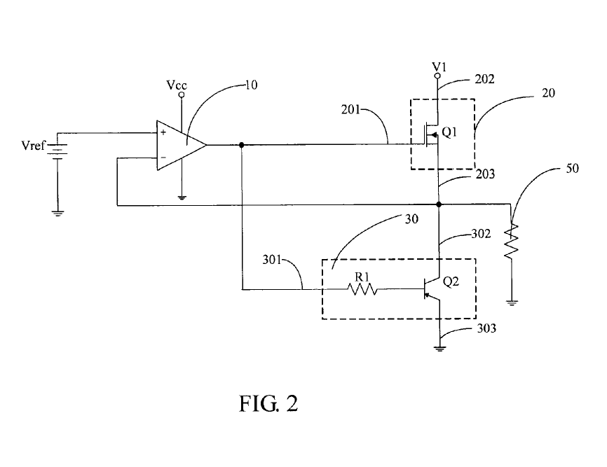

As shown in FIG. 2, in a first preferred embodiment of the present invention, a linear voltage regulator includes an error amplifier 10, a pass device 20, a leakage circuit 30.

An operational voltage Vcc is fed to the error amplifier 10 to make the error amplifier 10 function. A non-inverting of the error amplifier 10 receives a voltage reference Vref. An inverting of the error amplifier 10 is connected to the pass device 20 for sensing a load voltage of a load 50. A control signal from the output of the error amplifier 10 is fed to the pass device 20 for controlling the pass device 20. An N-channel metal-oxide-semiconductor field-effect transistor (MOSFER) Q1 is used as the pass device 20. A gate of the MODFET Q1 acts as a control terminal 201 of the pass device 20 for receiving the control signal. A source of the MODFET Q1 acts as an input terminal 202 of the pass device 20 for receiving an input voltage V1 provided by a power supply. A drain of the MODFET Q1 acts as an output terminal 203 of the pass device 20 for providing the load voltage of the load 50. The leakage circuit 30 includes a limiting resistor R1 and a switch transistor. An NPN bipolar transistor Q2 is employed as the switch transistor. A base of the bipolar transistor Q2 acts as a control end 301 for receiving the control signal via the limiting resistor R1. A collector of the bipolar transistor Q2 acts as an input end 302 for receiving the load voltage. An emitter of the bipolar transistor Q2 acts as an output end 303 for grounding.

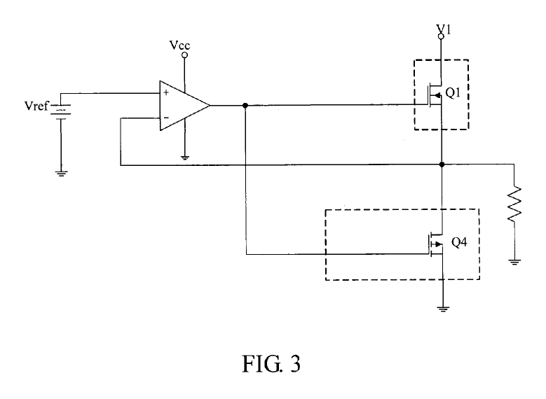

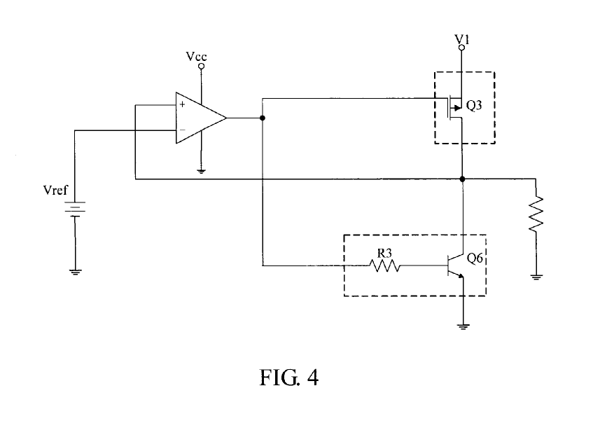

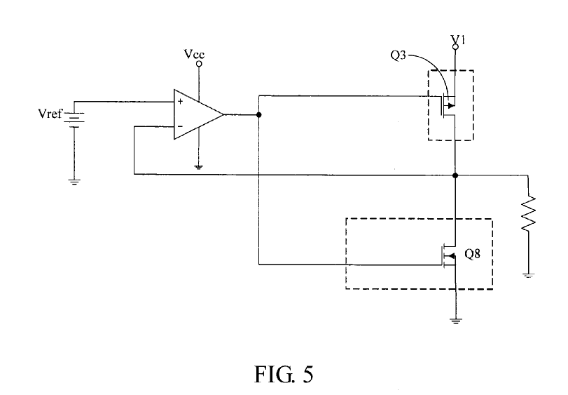

As shown in FIG. 3 to FIG. 5, the linear voltage regulator can employ a P-channel MOSFET Q3 as the pass device 20. The leakage circuit 30 can employ a PNP bipolar transistor Q2, a P-channel MOSFET Q4, or an N-channel MOSFET Q8 as the switch transistor.

When the linear voltage regulator operates normally, the control signal from the output of the error amplifier 10 controls the pass device 20 to provide current from a power supply to the load 50. The pass device 20 maintains a desired output voltage despite fluctuations in the load 50. The leakage circuit 30 does not function. When the linear voltage regulator operates abnormally, that is, when a back-drive current appears, the switch transistor Q2 of the leakage circuit 30 turns on. The back-drive current is grounded via the switch transistor Q2.

In the illustrated embodiment, because that the linear voltage regulator includes the leakage circuit 30, a drive-back current created can be grounded via the switch transistor of the leakage circuit 30 when the voltage delta appears, that is, the drive-back current can be consumed. For example, when the linear voltage regulator provides voltage to a front side bus (FSB), there is possibility a voltage delta appears due to a difference in a processor and a memory controller hub (MCH). When the FSB is inactive, the voltage delta creates a condition where a higher processor voltage creates a back-drive current in the MCH termination. The switch transistor of the leakage circuit 30 can consume the drive-back current. As a result, an impedance calibration of the active MCH front side bus termination transistors will be normal. And a life span of the MCH will be protected.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A linear voltage regulator comprising:
an error amplifier receiving an operational voltage and providing a control signal;
a pass device controlled by the control signal and providing a load voltage from a power supply; and
a leakage circuit controlled by the control signal and consuming a drive-back current.

2. The linear voltage regulator as claimed in claim 1, wherein the error amplifier comprises a first input, a second input and an output, the first receives a voltage reference, the second input receives the load voltage, and the output provides the control signal.

3. The linear voltage regulator as claimed in claim 1, wherein the pass device comprises a control terminal, an input terminal, and an output terminal, the control terminal receives the control signal from the output of the error amplifier, the input terminal receives a voltage provided by the power supply, and the output terminal provides the load voltage to the load.

4. The linear voltage regulator as claimed in claim 3, wherein the pass device is a N-channel metal-oxide-semiconductor field-effect transistor (MOSFET), a gate of the MOSFET acts as the control terminal, a drain of the MOSFET acts as the input terminal, and a source of the MOSFET acts as the output terminal.

5. The linear voltage regulator as claimed in claim 3, wherein the pass device is a P-channel MOSFET, a gate of the MOSFET acts as the control terminal, a source of the MOSFET acts as the input terminal, and a drain of the MOSFET acts as the output terminal.

6. The linear voltage regulator as claimed in claim 1, wherein the leakage circuit comprises a switch transistor, the switch transistor comprises a control end, an input end, and an output end, the control end receives the control signal, the input end receives the load voltage, and the output end is grounded.

7. The linear voltage regulator as claimed in claim 6, wherein the leakage circuit further comprises a limiting resistor, the control end receives the control signal via the limiting transistor.

8. The linear voltage regulator as claimed in claim 7, wherein the switch transistor is a PNP bipolar transistor, a base of the PNP bipolar transistor acts as the control end, a collector of the PNP bipolar transistor acts as the input end, an emitter of the PNP bipolar transistor acts as the output end.

9. The linear voltage regulator as claimed in claim 7, wherein the switch transistor is a NPN bipolar transistor, a base of the NPN bipolar transistor acts as the control end, an emitter of the NPN bipolar transistor acts as the input end, and a collector of the NPN bipolar transistor acts as the output end.

10. The linear voltage regulator as claimed in claim 6, wherein the switch transistor is an N-channel MOSFET, a gate of the MOSFET acts as the control end, a drain of the MOSFET acts as the input end, and a source of the MOSFET acts as the output end.

11. The linear voltage regulator as claimed in claim 6, wherein the switch transistor is an N-channel MOSFET, a gate of the MOSFET acts as the control end, a source of the MOSFET acts as the input end, and a drain of the MOSFET acts as the output end.

12. A linear voltage regulator comprising:
an error amplifier comprising a first input for receiving a voltage reference, a second input for receiving a load voltage, and an output for providing a control signal;
a pass device comprising a control terminal for receiving the control signal, an input terminal for receiving a voltage provided by a power supply, and an output terminal for providing the load voltage to a load; and
a switch transistor comprising a control end for receiving the control signal, an input end for receiving the load voltage, and an output end grounded.

13. The linear voltage regulator as claimed in claim 12, wherein the pass device is an N-channel metal-oxide-semiconductor field-effect transistor (MOSFET), a gate of the MOSFET acts as the control terminal, a drain of the MOSFET acts as the input terminal, a source of the MOSFET acts as the output terminal.

14. The linear voltage regulator as claimed in claim 12, wherein the pass device is a P-channel MOSFET, a gate of the MOSFET act as the control terminal, a source of the MOSFET act as the input terminal, a drain of the MOSFET act as the output terminal.

15. The linear voltage regulator as claimed in claim 12, wherein the switch transistor is a PNP bipolar transistor, a base of the PNP bipolar transistor acts as the control end, a collector of the PNP bipolar transistor acts as the input end, an emitter of the PNP bipolar transistor acts as the output end.

16. The linear voltage regulator as claimed in claim 12, wherein the switch transistor is a NPN bipolar transistor, a base of the NPN bipolar transistor acts as the control end, an emitter of the NPN bipolar transistor acts as the input end, a collector of the NPN bipolar transistor acts as the output end.

17. The linear voltage regulator as claimed in claim 12, wherein the switch transistor is N-channel MOSFET, a gate of the MOSFET acts as the control end, a drain of the MOSFET acts as the input end, a source of the MOSFET acts as the output end.

18. The linear voltage regulator as claimed in claim 12, wherein the switch transistor is N-channel MOSFET, a gate of the MOSFET acts as the control end, a source of the MOSFET acts as the input end, a drain of the MOSFET acts as the output end.
